(19) United States
(12) Patent Application Publication
(10) Pub. No.: US 2025/0367603 A1
(43) Pub. Date: Dec. 4, 2025

(54) TWO-LAYER, THREE-WAY CATALYST WITH SIGNIFICANTLY IMPROVED CO CONVERSION

(71) Applicant: UMICORE AG & CO. KG, Hanau-Wolfgang (DE)

(72) Inventors: Martin ROESCH, Rodgau (DE); Uta ALBOLD, Bad Orb (DE); Hanju JO, Langen (DE); Elena MUELLER, Pfungstadt (DE); Naina DEIBEL, Pfungstadt (DE)

(73) Assignee: UMICORE AG & CO. KG, Hanau-Wolfgang (DE)

(21) Appl. No.: 19/225,516

(22) Filed: Jun. 2, 2025

(30) Foreign Application Priority Data
Jun. 4, 2024 (DE) 102024115458.6

(51) Int. Cl. B01D 53/94; B01J 21/04; B01J 23/63; B01J 35/00; F01N 3/10; F01N 3/28

(52) U.S. Cl. CPC B01D 53/945; B01J 21/04; B01J 23/63; B01J 35/19; F01N 3/101; F01N 3/2807; B01D 2255/1021; B01D 2255/1023; B01D 2255/1025; B01D 2255/2061; B01D 2255/2063; B01D 2255/2065; B01D 2255/20715; B01D 2255/407; B01D 2255/9022; B01D 2255/908; B01D 2255/9155; B01D 2257/404; B01D 2257/502; B01D 2257/702; B01D 2258/014; F01N 2230/02; F01N 2330/02

(57) ABSTRACT

The present invention relates to a catalyst comprising two layers on an inert catalyst carrier. Layer A contains at least palladium as a platinum group metal, alumina, and a first cerium/zirconium/lanthanum/yttrium mixed oxide. A layer B applied to layer A contains at least rhodium as a platinum group metal, alumina, and a second cerium/zirconium/lanthanum/yttrium mixed oxide.

The present invention relates to a three-way catalyst constructed from two superimposed catalytically active layers and suitable for cleaning exhaust from internal combustion engines.

Three-way catalysts are used in order to clean the exhaust from substantially stoichiometrically operated internal combustion engines. In stoichiometric operation, the amount of air supplied to the engine is exactly the amount needed to completely combust the fuel. In this case, the combustion air ratio λ, also known as the air number, is exactly 1. Three-way catalysts at approximately λ=1 are capable of simultaneously converting hydrocarbons, carbon monoxide, and nitrogen oxides into harmless components.

As catalytically active materials, platinum group metals, in particular platinum, palladium and rhodium, which are, for example, present on γ alumina as the carrier material, are generally used. In addition, three-way catalysts contain oxygen storage materials, for example cerium/zirconium mixed oxides. In the latter, cerium oxide, a rare earth metal oxide, is the basic component for oxygen storage. In addition to zirconium oxide and cerium oxide, these materials can contain additional components such as further rare earth metal oxides or alkaline earth metal oxides. Oxygen storage materials are activated by applying catalytically active materials such as platinum group metals and thus also serve as a carrier material for the platinum group metals.

The components of a three-way catalyst can be present in a single coating layer on an inert catalyst carrier, see for example EP1541220B1.

However, double-layer catalysts are often used, which allow for separation of different catalytic processes and thus optimal coordination of the catalytic effects in the two layers. Catalysts of the latter type are disclosed, for example, in WO95/35152A1, WO2008/000449A2, EP0885650A2, EP1046423A2, EP1726359A1, and EP1974809B1.

EP1974809B1 discloses three-way double-layer catalysts containing cerium/zirconium mixed oxides in both layers, wherein the cerium/zirconium mixed oxide in the upper layer has a higher proportion of zirconium than the one in the lower layer.

EP1900416B1 describes three-way double-layer catalysts which contain mixed oxides of cerium, zirconium, and neodymium in both layers and additionally contain cerium/zirconium/yttrium/lanthanum oxide-alumina particles in the lower layer.

EP1726359A1 describes three-way double-layer catalysts containing cerium/zirconium/lanthanum/neodymium mixed oxides with a zirconium content of more than 80 mol % in both layers, wherein the cerium/zirconium/lanthanum/neodymium mixed oxide in the upper layer can have a higher proportion of zirconium than the one in the lower layer.

WO2008/000449A2 also discloses double-layer catalysts that contain cerium/zirconium mixed oxides in both layers, wherein the mixed oxide in the upper layer again has a higher proportion of zirconium. In part, the cerium/zirconium mixed oxides can also be replaced by cerium/zirconium/lanthanum/neodymium or cerium/zirconium/lanthanum/yttrium mixed oxides.

WO2009/012348A1 even describes three-layer catalysts, wherein only the middle and upper layers contain oxygen storage materials.

EP3045226A1 discloses three-way double-layer catalysts with improved aging stability, wherein a layer A lying directly on the catalyst carrier contains at least one platinum group metal, as well as a cerium/zirconium/RE mixed oxide, and a layer B, which is applied to layer A and is in direct contact with the exhaust flow, containing at least one platinum group metal, as well as a cerium/zirconium/RE mixed oxide, wherein RE stands for a rare earth metal other than cerium, characterized in that the proportion of RE oxide in the cerium/zirconium/RE mixed oxide of layer A is less than the proportion of RE oxide in the cerium/zirconium/RE mixed oxide of layer B.

EP4096811A1 describes a catalyst which, due to its further increased temperature stability compared to the catalysts of the prior art, has further decreased light-off temperatures and improved dynamic conversion capacity after aging. It comprises two layers on an inert catalyst carrier, wherein a layer A contains at least palladium as a platinum group metal, as well as a cerium/zirconium/lanthanum/yttrium mixed oxide, and a layer B applied to layer A contains at least rhodium as a platinum group metal, as well as a cerium/zirconium/lanthanum/yttrium mixed oxide. In both layers A and B, the lanthanum oxide content is between 1 wt. % and 5 wt. % relative to the cerium/zirconium/lanthanum/yttrium mixed oxide, and the yttrium oxide content is between 8 wt. % and 20 wt. % relative to the cerium/zirconium/lanthanum/yttrium mixed oxide.

The ever-increasing requirements for emissions reduction in internal combustion engines necessitate continuous development of catalysts. Since July 2023, the CN6b legislative stage has been in effect in China. This legislation sets a carbon monoxide (CO) limit of 500 mg/km for passenger vehicles. The CN6b limit values must be maintained over a mileage of 200,000 km. Additionally, CN6b requires exhaust measurements under real-world conditions on the road (Real Driving Emissions RDE). Depending on driving conditions, this can result in significantly higher requirements for the catalyst, in particular regarding the dynamic conversion of carbon monoxide (CO) and nitrogen oxides (NOx).

The goal is to maintain stoichiometric exhaust under all driving conditions, in particular at high speeds. The previously common practice of enriching the fuel mixture to lower exhaust temperature should be avoided, as it leads to high CO emissions and increases fuel consumption. However, by avoiding fuel enrichment, the exhaust temperature to which the catalyst is exposed at high speeds continues to increase. The catalyst must meet these further increased requirements. This is also why a further increase in the aging stability of three-way catalysts is required.

The catalysts according to the prior art cited above already have very good properties with respect to dynamic conversion capacity after aging. However, the increased regulatory requirements necessitate the search for even better catalysts. In particular, adherence to the low limit value for CO at CN6b is very challenging and requires targeted improvement of catalyst performance.

Therefore, the problem addressed by this invention was to provide a catalyst that exhibits significantly improved conversion of CO under dynamic conditions.

The subject matter of the present invention is thus a catalyst comprising two layers on an inert catalyst carrier, wherein a layer A contains at least palladium as a platinum group metal, alumina, and a first cerium/zirconium/lanthanum/yttrium mixed oxide, and a layer B applied to layer A containing at least rhodium as a platinum group metal, alumina, and a second cerium/zirconium/lanthanum/yttrium mixed oxide.

In layer A, the cerium oxide content is between 40 wt. % and 50 wt. % relative to the first cerium/zirconium/lanthanum/yttrium mixed oxide, the lanthanum oxide content is between 2 wt. % and 10 wt. % relative to the first cerium/zirconium/lanthanum/yttrium mixed oxide, and the yttrium oxide content is between 2 wt. % and 8 wt. % relative to the first cerium/zirconium/lanthanum/yttrium mixed oxide. The mass ratio of mixed oxide to alumina is at least 1.5:1 and no more than 1.75:1.

In layer B, the cerium oxide content is between 20 wt. % and 30 wt. % relative to the second cerium/zirconium/lanthanum/yttrium mixed oxide, the lanthanum oxide content is between 1 wt. % and 5 wt. % relative to the second cerium/zirconium/lanthanum/yttrium mixed oxide, and the yttrium oxide content is between 8 wt. % and 20 wt. % relative to the second cerium/zirconium/lanthanum/yttrium mixed oxide.

By adjusting the composition of the mixed oxide and the ratio of amounts of the components of the lower layer, a solution for the problem has now surprisingly been found. By providing the lower layer of the catalyst according to the invention with a mass ratio of mixed oxide to alumina of at least 1.5:1 and no more than 1.75:1, preferably between 1.6:1 and 1.7:1, three-way catalysts are obtained that exhibit significantly improved catalytic conversion of CO under dynamic conditions compared to known three-way catalysts.

A preferred embodiment is characterized in that, in layer A, the cerium oxide content is between 43 wt. % and 46 wt. % relative to the first cerium/zirconium/lanthanum/yttrium mixed oxide, the lanthanum oxide content is between 5 wt. % and 7 wt. % relative to first the cerium/zirconium/lanthanum/yttrium mixed oxide, and the yttrium oxide content is between 4 wt. % 6 wt. % and relative to the first cerium/zirconium/lanthanum/yttrium mixed oxide. In this preferred embodiment, in layer B, the cerium oxide content is between 23 wt. % and 25 wt. % relative to the second cerium/zirconium/lanthanum/yttrium mixed oxide, the lanthanum oxide content is between 2 wt. % and 4 wt. % relative to the second cerium/zirconium/lanthanum/yttrium mixed oxide, and the yttrium oxide content is between 12 wt. % and 13 wt. % relative to the second cerium/zirconium/lanthanum/yttrium mixed oxide.

In a further preferred embodiment, in layer B, the catalyst according to the invention has the mass ratio of the second cerium/zirconium/lanthanum/yttrium mixed oxide to alumina of at least 1:1 and at most 1.5:1, preferably 1.2:1 to 1.35:1.

As shown in the examples, this can achieve very good conversion of CO despite intense aging, which ultimately ensures fewer emissions in dynamic driving operation.

According to the invention, layer A contains at least palladium as a platinum group metal, and layer B contains at least rhodium as a platinum group metal. In embodiments of the present invention, layer A and/or layer B additionally contain platinum as a further platinum group metal, independently of one another. Preferably, layer A contains palladium and platinum and layer B contains rhodium and platinum or rhodium and palladium and platinum. In further embodiments of the present invention, the catalyst according to the invention is free of platinum. Particularly preferably, layer A contains only palladium and layer B contains only rhodium, or layer B contains only palladium and rhodium.

Cerium/zirconium/lanthanum/yttrium mixed oxides can serve as carrier materials for the platinum group metals in layer A and/or layer B. Moreover, the platinum group metals in layer A and/or layer B can also be fully or partially carried on active alumina.

In a preferred embodiment of the present invention, layer A and layer B contain active alumina. It is particularly preferred when the active alumina is stabilized by doping, in particular with lanthanum oxide. Preferred active aluminas contain 0.5 to 6 wt. %, in particular 3 to 5 wt. %, of lanthanum oxide (La₂O₃).

The term “active alumina” is known to the person skilled in the art. It denotes in particular γ alumina having a specific surface area of 100 m²/g to 200 m²/g. Active alumina is described extensively in the literature and is available on the market.

The term “cerium/zirconium/lanthanum/yttrium mixed oxide” in the context of the present invention excludes physical mixtures of cerium oxide, zirconium oxide, lanthanum oxide, and yttrium oxide. Rather, “cerium/zirconium/lanthanum/yttrium mixed oxides” are characterized by a largely homogeneous, three-dimensional crystal structure that is ideally free of phases of pure cerium oxide, zirconium oxide, lanthanum oxide, and yttrium oxide. Depending on the manufacturing process, products that are not completely homogeneous can also be produced, which can generally be used without disadvantages.

The cerium/zirconium/lanthanum/yttrium mixed oxides of the present invention do not contain any alumina in their crystal structure.

In embodiments of the present invention, one or both layers contain alkaline earth compounds, such as barium oxide or barium sulfate. Preferred embodiments contain barium sulfate in layer A. The amount of barium sulfate is in particular 5 g/l to 20 g/l volume of the inert catalyst carrier.

In further embodiments of the present invention, one or both layers additionally contain additives such as rare earth compounds like lanthanum oxide and/or binders such as aluminum compounds. These additives are used in amounts that can vary widely and which the person skilled in the art can determine by simple means in the specific case.

In a further embodiment of the present invention, layer A lies directly on the inert catalyst carrier, i.e., there is no further layer or “undercoat” between the inert catalyst carrier and layer A. In a further embodiment of the present invention, layer B is in direct contact with the exhaust flow, i.e., there is no further layer or “overcoat” on layer B.

In a further embodiment of the present invention, the catalyst according to the invention consists of layers A and B on an inert catalyst carrier. This means that layer A lies directly on the inert catalyst carrier, layer B is in direct contact with the exhaust flow, and no further layers are present.

As catalytically inert catalyst carriers, honeycomb bodies made of ceramic or metal with a volume V are suitable. These bodies have parallel flow channels for the exhaust of the internal combustion engine. They can be either so-called flow-through honeycomb bodies or wall-flow filters. In particular in the case of a wall-flow filter, the catalytic coating according to the invention can be located entirely on, partially in, or completely in the wall of the wall-flow filter.

According to the invention, the wall surfaces of the flow channels are coated with the two catalyst layers A and B. To coat the catalyst carrier with layer A, the solids intended for this layer are suspended in water. The catalyst carrier is then coated with the resulting coating suspension, if necessary, on and/or in the wall. The process is repeated with a coating suspension containing the solids intended for layer B, being suspended in water.

Preferably, both layer A and layer B are coated over the entire length of the inert catalyst carrier. This means that layer B completely covers layer A, and consequently, only layer B comes into direct contact with the exhaust flow. However, a zoned coating variant is possible, in which layer A is at least partially covered by layer B.

The subject matter of the present invention is also an exhaust system for reducing the harmful components in the exhaust of an internal combustion engine, in particular one that is operated primarily stoichiometrically, comprising a catalyst according to the invention. Moreover, the exhaust system can contain other exhaust cleaning components known to the person skilled in the art for this purpose. Preferably, the exhaust system further comprises a particulate filter. Advantageous exhaust systems in which at least one of the three-way catalysts can be replaced by the one according to the invention are described, for example, in WO2020079131A1.

The present invention further relates to the use of a catalyst or exhaust system according to the invention in order to reduce harmful components in the exhaust of an internal combustion engine, in particular one that is operated primarily stoichiometrically. However, a preferred use is when the internal combustion engine spends more than 90% of its operating time, preferably 100% of its operating time, in a state where it does not burn a rich exhaust mixture. There is a latent risk here that the catalyst according to the invention will be exposed to high exhaust temperatures. For normal catalysts, this would result in a rapid decrease in cleaning performance. The result is that more exhaust can reach the atmosphere without being reduced. However, the three-way catalyst according to the invention can obviously maintain its cleaning effect to a particularly impressive extent under these exhaust temperatures. This was more than surprising in light of the prior art.

### EXAMPLES

In the following Example 1 and Comparative Examples 1-3, two-layer catalysts were produced by twice coating honeycomb carriers made of ceramic with 93 cells per cm² and wall thickness 0.11 mm, with dimensions of 11.8 cm in diameter and 11.4 cm in length. For this purpose, two different suspensions for layer A and B were produced. The carrier was first coated with the suspension for layer A and subsequently calcined in air for 4 hours at 550° C. Thereafter, the carrier coated with layer A was coated with the suspension for layer B and subsequently calcined under the same conditions as layer A.

Example 1 according to the present invention contains a higher proportion of mixed oxide in layer A than Comparative Examples 1-3. The mass ratio of mixed oxide to alumina in Example 1 is 1.66:1, while the Comparative Examples each have a ratio of mixed oxide to alumina of 1:1.

### Example 1 (According to the Invention)

A two-layer catalyst was prepared by first producing two suspensions. The composition of the first suspension for Layer A (relative to the volume of the catalyst carrier) was 49.4 g/L with 4 wt % La₂O₃ stabilized activated alumina, 82.3 g/L cerium/zirconium/lanthanum/yttrium mixed oxide with 44.5 wt % CeO₂, 44.5 wt % ZrO₂, 6 wt % La₂O₃, and 5 wt % Y₂O₃, 16 g/L BaSO₄, 0.954 g/L Pd.

The composition of the second suspension for layer B (relative to the volume of the catalyst carrier) was 47 g/L with 4 wt % La₂O₃ stabilized activated alumina, 60 g/L cerium/zirconium/lanthanum/yttrium mixed oxide with 24 wt % CeO₂, 60 wt % ZrO₂, 3.5 wt % La₂O₃, and 12.5 wt % Y₂O₃, 0.106 g/L Rh.

### Comparative Example 1 (According to EP3045226A1)

A two-layer catalyst was prepared analogously to Example 1. The composition of the first suspension for Layer A was 66 g/L with 4 wt % La₂O₃ stabilized activated alumina, 66 g/L cerium/zirconium/lanthanum/yttrium mixed oxide with 25 wt % CeO₂, 67.5 wt % ZrO₂, 3.5 wt % La₂O₃, and 4 wt % Y₂O₃, 16 g/L BaSO₄, 0.954 g/L Pd.

The composition of the second suspension for layer B was the same as in Example 1.

### Comparative Example 2 (According to EP4096811A1)

A two-layer catalyst was prepared analogously to Example 1. The composition of the first suspension for Layer A (relative to the volume of the catalyst carrier) was 66 g/L with 4 wt % La₂O₃ stabilized activated alumina, 66 g/L cerium/zirconium/lanthanum/yttrium mixed oxide with 24 wt % CeO₂, 60 wt % ZrO₂, 3.5 wt % La₂O₃ and 12.5 wt % Y₂O₃, 16 g/L BaSO₄, 0.954 g/L Pd.

The composition of the second suspension for layer B was the same as in Example 1.

### Comparative Example 3 (According to EP1974809B1)

A two-layer catalyst was prepared analogously to Example 1. The composition of the first suspension for layer A (relative to the volume of the catalyst carrier) was 66 g/L with 4 wt % La₂O₃ stabilized activated alumina, 66 g/L cerium/zirconium/lanthanum/yttrium mixed oxide with 44.5 wt % CeO₂, 44.5 wt % ZrO₂, 6 wt % La₂O₃, and 5 wt % Y₂O₃, 16 g/L BaSO₄, 0.954 g/L Pd.

The composition of the second suspension for layer B was the same as in Example 1.

Example 1 and Comparative Examples 1-3 were aged in an engine test bench aging process. The aging consisted of an overrun fuel cut-off aging with a 950° C. exhaust temperature in front of the catalyst inlet. This resulted in a maximum bed temperature of 1020° C. in the catalyst. The aging time was 38 hours.

Subsequently, the dynamic conversion was determined on an engine test bench in a range for I from 0.99 to 1.01 at a constant temperature of 510° C. The amplitude of I was ±6.8%, and the exhaust mass flow was 190 kg/h. Table 2 shows the conversion at the intersection of the CO and NOx conversion curves, as well as the associated HC conversion.

Table 1 shows the conversion at the intersection of the CO and NOx conversion curves, as well as the associated HC conversion.

TABLE 1
Dynamic conversion

| | CO/NOx conversion | HC conversion |
|---|---|---|
| | at the cross-over | at I the CO/NOx |
| | point | cross-over point |
| Example 1 | 87% | 91% |
| Comparative Example 1 | 83.5% | 91% |
| Comparative Example 2 | 85.5% | 91 |
| Comparative Example 3 | 84% | 90.5 |

Example 1 according to the invention shows a clear improvement in dynamic CO/NOx conversion after aging, compared to all Comparative Examples.

Furthermore, emissions were determined on a highly dynamic engine test bench with a 1.2 L gasoline direct-injection engine and exhaust turbocharger in a very dynamic travel cycle (RTS 95 or RTS Aggressive RTS 95 Cycle (dieselnet.com)). Table 2 shows the measured emissions.

TABLE 2
Emissions in RTS 95 Cycle

| | CO Emission | NOx Emission | HC Emission |
|---|---|---|---|
| | (mg/km) | (mg/km) | (mg/km) |
| Example 1 | 732 | 72 | 61 |
| Comparative | 878 | 68 | 56 |
| Example 1 | | | |
| Comparative | 875 | 69 | 57 |
| Example 2 | | | |
| Comparative | 833 | 74 | 60 |
| Example 3 | | | |

Example 1 according to the invention shows a very clear improvement over Comparative Example 1 of almost 17% in CO emissions and only slight disadvantages in NOx (<6%) and HC emissions (<9%).

1. A catalyst comprising two layers arranged one above the other on an inert catalyst carrier, wherein
a layer A contains at least palladium as a platinum group metal, alumina, and a first cerium/zirconium/lanthanum/yttrium mixed oxide, and
a layer B applied to layer A contains at least rhodium as a platinum group metal, alumina, and a second cerium/zirconium/lanthanum/yttrium mixed oxide,
characterized in that
in layer A, the cerium oxide content is between 40 wt. % and 50 wt. % relative to the first cerium/zirconium/lanthanum/yttrium mixed oxide, the lanthanum oxide content is between 2 wt. % and 10 wt. % relative to the first cerium/zirconium/lanthanum/yttrium mixed oxide, and the yttrium oxide content is between 2 wt. % and 8 wt. % relative to the first cerium/zirconium/lanthanum/yttrium mixed oxide, and the mass ratio of the first cerium/zirconium/lanthanum/yttrium mixed oxide to alumina is at least 1.5:1 and at most 1.75:1,
and in layer B, the cerium oxide content is between 20 wt. % and 30 wt. % relative to the second cerium/zirconium/lanthanum/yttrium mixed oxide, the lanthanum oxide content is between 1 wt. % and 5 wt. % relative to the second cerium/zirconium/lanthanum/yttrium mixed oxide, and the yttrium oxide content is between 8 wt. % and 20 wt. % relative to the second cerium/zirconium/lanthanum/yttrium mixed oxide.

2. The catalyst according to claim 1, characterized in that layer A and/or layer B, independently of one another, additionally contain platinum as a further platinum group metal.

3. The catalyst according to claim 1, characterized in that, as a platinum group metal, layer A contains only palladium and layer B contains only rhodium, or layer B contains only palladium and rhodium.

4. The catalyst according to claim 1, characterized in that layer A and layer B contain active alumina.

5. The catalyst according to claim 4, characterized in that the platinum group metal is carried in layer A and/or in layer B entirely or partially on active alumina.

6. The catalyst according to claim 1, characterized in that, in layer B, the mass ratio of the second cerium/zirconium/lanthanum/yttrium mixed oxide to alumina is at least 1:1 and at most 1.5:1.

7. The catalyst according to claim 1, characterized in that layer A lies directly on the inert catalyst carrier.

8. An exhaust system for reducing the harmful components in the exhaust of an internal combustion engine, which is operated in particular primarily stoichiometrically, the exhaust system comprising a catalyst according to claim 1.

9. The exhaust system according to claim 8, characterized in that it further comprises a particulate filter.

10. A use of a catalyst according to claim 1 to reduce the harmful components in the exhaust of an internal combustion engine, which is operated in particular primarily stoichiometrically.

11. The use according to claim 10, characterized in that it relates to an internal combustion engine that it spends more than 90% of its operating time in a state of not combusting any rich exhaust mixture.
